(19) United States
(12) Patent Application Publication
(10) Pub. No.: US 2026/0327357 A1
(43) Pub. Date: Oct. 22, 2026

(54) UNIMODAL LINEAR LOW-DENSITY ETHYLENE/1-BUTENE COPOLYMERS

(71) Applicant: Univation Technologies, LLC, Houston, TX (US)

(72) Inventors: Bo Liu, Pearland, TX (US); Feng Chen, Shanghai (CN); Shadid Askar, Houston, TX (US); Chuan C. He, Missouri City, TX (US); Rongjuan Cong, Lake Jackson, TX (US); Swapnil B. Chandak, Pearland, TX (US)

(21) Appl. No.: 19/099,588

(22) PCT Filed: Aug. 31, 2022
(86) PCT No.: PCT/CN2022/116172

§ 371 Date: Jan. 29, 2025

(51) Int. Cl. C08F 210/16; C08F 4/6592; C08J 5/18

(52) U.S. Cl. CPC C08F 210/16; C08F 4/65927; C08J 5/18; C08J 2323/08

(57) ABSTRACT

A unimodal linear low-density ethylene/1-butene copolymer made by copolymerizing ethylene and 1-butene using a bridged bis(tetrahydroindenyl) zirconocene catalyst. A post-reactor blend comprising the unimodal linear low-density ethylene/1-butene copolymer and a different polyolefin polymer. A film comprising the unimodal linear low-density ethylene/1-butene copolymer. A method of making the unimodal linear low-density ethylene/1-butene copolymer. A method of making the film.

### FIELD

Polyethylenes, polyolefin blends, plastic films, polymerization processes, and methods.

### INTRODUCTION

Patent application publications and patents in or about the field include U.S. patent numbers U.S. Pat. Nos. 4,781,297; 5,336,746; 5,466,649; 5,525,689; 5,374,700; 5,639,842; 5,712,352; 5,763,543; 6,476,171 B1; U.S. Pat. No. 6,870,010 B1; U.S. Pat. No. 8,957,159 B2; U.S. Pat. No. 10,370,469 B2; and U.S. Pat. No. 10,508,164 B2; and U.S. patent application publication numbers US2005/0100753 A1 and US 2021/0070902 A1.

### SUMMARY

Most plastic films are only slightly easier to tear in the machine direction (MD)—the forward direction the film takes when it leaves a film extruder die (see MD arrow in FIG. 1) and its opposite or “anti-machine” direction opposite to MD arrow in FIG. 1)—than in the cross direction (CD, sometimes called the transverse direction (TD))—the side-to-side direction perpendicular to MD direction (see CD arrow in FIG. 1 for one side-to-side direction). The direction of tearing of these films cannot be controlled. In bags, packages, and container liners such as box or drum liner, this lack of directional tear control can result in loss of containment of materials held inside.

A challenge in the plastic film industry is to find new films with high directional tearability. This means, simplistically, that such films would be significantly easier to tear in the machine direction than in the cross direction. This lesser resistance to tearing in one direction versus the other would offer advantages to end users. For example, if the tearability in the machine direction is sufficiently high (i.e., resistance to tearing is sufficiently low), while resistance to tearing in the cross direction is sufficiently high (CD tearability is low), end users, such as consumers, would be able to tear open by hand a bag, package, or container liner without the aid of a cutting blade and without loss of containment of the materials held inside.

One way to attempt this is to take a reference film and modify its resin composition to try to selectively increase its tearability in the machine direction while at the same time minimizing increase in tearability in the cross direction. This is easier said than done because blown film performance rests on a three-legged stool-like balance of properties comprising resin melt processability, film directional tearability, and film overall toughness. If directional tearability is increased, melt processability and/or overall film toughness is often undesirably decreased. This can lead to blown film defects such as bubble instability, thickness variations, wrinkles, lines, rough surfaces due to melt fracture, holes, or tears.

We have discovered a new linear low-density polyethylene (LLDPE) resin that can be used to manufacture blown LLDPE films that have this improved (increased) directional tearability without harming melt processability or overall toughness. The new LLDPE films are easy to tear in the machine direction (MD) or anti-machine direction (opposite to MD), but difficult to tear in the cross direction (CD) or anti-cross direction. The new LLDPE resin has sufficient melt processability that enables it to be used under standard film blowing conditions on monolayer and multilayer film blowing lines such that the new LLDPE films are formed without defects. The new LLDPE films have an overall toughness that enables them to hold up under the normal abuses of end use operations (e.g., a packaging operation such as wrapping a pallet of boxes with the film) and shipping and handling of the end use product (e.g., shipping and handling the wrapped pallet of goods). The new LLDPE films have good optical clarity and haze. The following embodiments of the present invention include:

A unimodal linear low-density ethylene/1-butene copolymer (“C4-uLLDPE”), made by copolymerizing ethylene and 1-butene using a bridged bis(tetrahydroindenyl) zirconocene catalyst.

A post-reactor blend comprising the unimodal linear low-density ethylene/1-butene copolymer (“C4-uLLDPE”) and a different polyolefin polymer.

A method of making a film comprising the unimodal linear low-density ethylene/1-butene copolymer (“C4-uLLDPE”) or the post-reactor blend.

A film comprising the unimodal linear low-density ethylene/1-butene copolymer (“C4-uLLDPE”) or the post-reactor blend.

### BRIEF DESCRIPTION OF THE DRAWINGS

FIG. 1 is a view of a roll of a monolayer film that is shown partially unrolled (or incompletely rolled up) with perpendicular arrows to illustrate the machine direction (MD) and cross direction (CD).

FIG. 2 has pictorial illustrations of chain structures of LLDPE, LDPE, and HDPE.

FIG. 3 is a schematic cross-sectional view of a multilayer film structure comprising three film layers.

FIG. 4 is a schematic cross-sectional view of a multilayer film structure comprising seven film layers.

### DETAILED DESCRIPTION

Activator (for metallocene procatalysts): a Lewis acid, a non-coordinating ionic activator, or an ionizing activator, or a Lewis base, an alkylaluminum, or an alkylaluminoxane (alkylalumoxane). The activator may be methylaluminoxane (MAO), ethylaluminoxane, 2-methylpropyl-aluminoxane, or a modified methylaluminoxane (MMAO). The molar ratio of activator's aluminum to the bridged bis(tetrahydroindenyl) zirconocene procatalyst's zirconium (Al/Zr molar ratio) may be 1000:1 to 0.5:1, alternatively 300:1 to 1:1, alternatively 150:1 to 1:1.

1-Butene or “C4”: a compound of formula H₂C═CHCH₂CH₃.

Ethylene or “C2”: a compound of formula H₂C═CH₂.

Film: a continuous layer of polymeric material having a thickness of from greater than 5 micrometers (μm) to 250 μm, as defined in ASTM Terminology D883. Film thickness is measured according to ASTM D6988-21, Standard Guide for Determination of Thickness of Plastic Film Test Specimens.

1-Hexene or “Cg”: a compound of formula H₂C═CHCH₂CH₂CH₂CH₃.

In-reactor: occurring during a polymerization process and at a location inside a polymerization reactor.

In-reactor blend: a mixture that is made in a polymerization reactor by making a second polymer in the presence of a first polymer in-situ in the polymerization reactor, and wherein either the first polymer is made before the second polymer is made or the first and second polymers are made together simultaneously.

LLDPE (linear low-density polyethylene) versus LDPE (low-density polyethylene) versus HDPE (high-density polyethylene). These polyethylenes have different polymer chain structures, which are pictorially illustrated in FIG. 2, and are a result of the different polymerization process conditions and initiators or catalysts used to make them. In general an LLDPE is distinguished from LDPE by the initiator or catalyst and the polymerization process conditions used to make them, which leads to differences in their amounts of long chain branching. LDPE is made by a free radical polymerization process (e.g., initiated by small amounts of organic peroxide) at high pressure and as such LDPE inherently has a significant amount of long chain branching as shown in FIG. 2. Prior LLDPEs are made using traditional Ziegler-Natta catalysts, which do not generate long chain branching, and so prior LLDPEs are linear and free of long chain branching as illustrated in FIG. 2. In general an LLDPE is distinguished from HDPE by density and by the amount of short chain branching (SCB). LLDPEs have densities less than 0.940 g/cm³, whereas HDPE has densities greater than or equal to 0.940 g/cm³. Also, LLDPEs have a significant amount of short chain branching, whereas HDPEs have far lesser amounts of short chain branching, as shown in FIG. 2.

Modality or (prefix)-modal refers to the nature of a polymer's molecular weight distribution above a molecular weight of 1,000 grams/mole (Log (MW)>3.0) in a plot of dW/dLog (MW) on the y-axis versus Log (MW) on the x-axis to give a Gel Permeation Chromatograph (GPC) chromatogram, wherein Log (MW) and dW/dLog (MW) are as defined herein and are measured by the High Temperature Gel Permeation Chromatography (GPC) Test Method described later. The modality may be unimodal or multimodal and the multimodal may be bimodal, trimodal, or higher. The unimodal molecular weight distribution is characterized by one and only one GPC peak. The multimodal MWD is characterized by two or more peaks. When the multimodal MWD has two and only two peaks, it is bimodal (bimodal MWD). Any two peaks in the multimodal MWD may be separated by a distinguishable local minimum therebetween or one peak may merely be a shoulder on the other.

Procatalyst: a catalyst precursor that when contacted with an activator makes a catalyst.

Ziegler-Natta catalyst: generally is a titanium catalyst supported on magnesium dichloride solids, and, optionally, a silica. The catalyst is made by contacting a Ziegler-Natta procatalyst with a suitable activator, which is different than activators for metallocenes. The typical Ziegler-Natta (pro) catalyst comprises a titanium (IV) compound (e.g., Ti(O-isopropyl)₄ or TiCl₄) supported on magnesium halide (e.g., MgCl₂) solids and, optionally, a hydrophobic fumed silica (e.g., Cab-O-Sil TS-610). The procatalyst may be unmodified, i.e., free of a modifier compound or the Ziegler-Natta (pro) catalyst may be modified by a modifier compound. The modifier compound may be an unsubstituted ether, an unsubstituted alcohol, or a combination thereof; e.g., tetrahydrofuran, ethanol, or a combination of tetrahydrofuran (“THF”) and ethanol (“EtOH”). Ziegler-Natta catalysts generally make polyethylenes having broader molecular weight distributions (higher polydispersity index values) than metallocene catalysts.

An embodiment is a unimodal linear low-density ethylene/1-butene copolymer (“inventive C4-uLLDPE” or simply “C4-uLLDPE”) that Is made by copolymerizing ethylene and 1-butene using a bridged bis(tetrahydroindenyl) zirconocene catalyst selected from the group consisting of: an ethylene bis(4,5,6,7-tetrahydroindenyl) zirconium dichloride, ethylene bis(4,5,6,7-tetrahydroindenyl) zirconium dimethyl, dimethylsilyl bis(4,5,6,7-tetrahydroindenyl) zirconium dichloride, dimethylsilyl bis(4,5,6,7-tetrahydroindenyl) zirconium dimethyl, diphenylsilyl bis(4,5,6,7-tetrahydroindenyl) zirconium dichloride, diphenylsilyl bis(4,5,6,7-tetrahydroindenyl) zirconium dimethyl, diethylsilyl bis(4,5,6,7-tetrahydroindenyl) zirconium dichloride, and diethylsilyl bis(4,5,6,7-tetrahydroindenyl) zirconium dimethyl; wherein the unimodal linear low-density ethylene/1-butene copolymer is characterized be each of the following properties: a density from 0.915 to 0.939 gram per cubic centimeter (g/cm³) measured according to ASTM D792-13, Method B; a melt index (I₂) from 0.1 to 4.0 grams per 10 minutes (g/10 min.) measured according to ASTM D1238-13, using conditions of 190° C./2.16 kg; and a polydispersity index M_{w}/Mₙ from 3.0 to 5.0 measured according to the High Temperature Gel Permeation Chromatography (GPC) Test Method in the description. The C4-uLLDPE may be made by copolymerizing ethylene and 1-butene using the bridged bis(tetrahydroindenyl) zirconocene catalyst in a gas phase polymerization reactor such as a floating bed gas phase polymerization reactor described later. Another chemical name for the C4-uLLDPE is a unimodal linear low-density polyethylene-co-1-butene) copolymer.

The C4-uLLDPE may have a density from 0.921 to 0.939 g/cm³, alternatively from 0.921 to 0.929 g/cm³, alternatively from 0.920 to 0.924 g/cm³, alternatively from 0.926 to 0.930 g/cm³, alternatively from 0.935 to 0.939 g/cm³. The density is measured according to ASTM D792-13, Method B.

The C4-uLLDPE may have a melt index (I₂) from 0.2 to 1.4 g/10 min., alternatively from 0.2 to 0.7 g/10 min., alternatively from 0.8 to 1.2 g/10 min. The melt index (I₂) is measured according to ASTM D1238-13, using conditions of 190° C./2.16 kg.

The C4-uLLDPE may have a polydispersity index M_{w}/Mₙ from 3.5 to 4.5, alternatively from 3.6 to 4.1, alternatively from 3.9 to 4.4, alternatively from 3.5 to 3.9, alternatively from 3.8 to 4.2, alternatively from 4.1 to 4.5. The M_{w} is weight-average molecular weight and Mₙ is number-average molecular weight and the M_{w} and Mₙ values are measured according to the High Temperature Gel Permeation Chromatography (GPC) Test Method described later.

The C4-uLLDPE may have a long-chain branching (LCB) content from 0.005 to 0.050 per 1000 carbon atoms (content/1000C), alternatively from 0.015/1000C to 0.034/1000C, alternatively from 0.020/1000C to 0.030/1000C, measured by carbon-13 nuclear magnetic resonance (¹³C-NMR) spectroscopy according to the LCB Value Test Method in the description. As used herein having a LCB content means having an amount of long chain branching that is detectable by the ¹³C-NMR spectroscopy, which currently has a lower detection limit of 0.004/1000C. LCB content from greater than 0.000 to less than 0.005 are excluded herein.

The C4-uLLDPE may have at least one of properties (I) to (Iv): (I) a density from 0.921 to 0.939 g/cm³; (ii) a melt index (I₂) from 0.2 to 1.4 g/10 min.; (iii) a polydispersity index M_{w}/Mₙ from 3.5 to 4.5; and (iv) a long chain branching content from 0.005/1000C to 0.050/1000C. In some embodiments the C4-uLLDPE has any one of property combinations (v) to (xii): (v) properties (I) and (ii): (vi) properties (i) and (iii); (vii) properties (i) and (iv); (viil) properties (ii) and (iii); (ix) properties (ii) and (iv): (x) properties (iii) and (iv); (xi) any three of properties (i) to (iv); and (xii) each of properties (i) to (iv).

Normally, if a conventional unimodal linear low-density ethylene/1-butene copolymer (conventional C4-uLLDPE) is to have sufficient melt processability characteristics to allow the conventional C4-uLLDPE to be melt blown into a film, the conventional C4-uLLDPE must have a broad polydispersity index M_{w}/Mₙ greater than 15, and more typically greater than 20. These M_{w}/Mₙ requirements also would apply to multimodal linear low-density polyethylenes, which naturally have higher values for M_{w}/Mₙ due to their multimodality anyway. In such a conventional C4-uLLDPE, it is its broad molecular weight distribution of polymer chains that enables the required melt processability. This broad molecular weight distribution, however, is absent in the inventive C4-uLLDPE, and yet surprisingly the inventive C4-uLLDPE does have sufficient melt processability characteristics such that the inventive C4-uLLDPE is able to be melt blown into the inventive film. Without being bound by theory, the inventors believe that the beneficial melt processability of the inventive C4-uLLDPE is due to the inventive C4-uLLDPE having a greater amount of long chain branching (LCB) content than the conventional C4-uLLDPE, and somehow this higher LCB content facilitates the melt processability into blown films. It is believed that the higher LCB content is a result of the inventive C4-uLLPDE being made by the bridged bis(tetrahydroindenyl) zirconocene catalyst, rather than an unbridged metallocene catalyst. Alternatively or additionally, the C4-uLLDPE may have a different type of long chain branching than the long chain branching of the comparative C6-uLLDPE copolymer. It is believed that improved Delta (SCBD) may also contribute to the improved processability of the C4-uLLDPE.

Optionally in some embodiments the C4-uLLDPE is characterized by at least one of the following properties: a melt flow ratio (I₂₁/I₂) characterized by Equation (A) described later; melt flow ratio (I₂₁/I₂); high load melt index (I₂₁); an improved Delta (SCBD) determined by comonomer content distribution analysis (iCCD) using the Delta (SCBD) Test Method described later; composition distribution breadth index (CDBI) measured by iCCD; number-average molecular weight (Mₙ); weight-average molecular weight (M_{w}); or the ratio of M_{w}/Mₙ (polydispersity index).

The long chain branching (LCB) content of the inventive C4-uLLDPE may be directly or indirectly characterized by any one of the following measurements (i) to (iii): (I) directly by carbon-13 nuclear magnetic resonance (NMR) spectroscopy; (ii) indirectly by a melt flow ratio (I₂₁/I₂) equation described below; or (iii) indirectly by a melt flow ratio (I₂₁/I₂) range. In some embodiments the characterization may comprise a combination of measurements (i) and (ii), measurements (i) and (iii), measurements (ii) and (iii), or measurements (i), (ii), and (iii). The measurements (j) to (iii) and their ranges are described below.

In some embodiments the C4-uLLDPE may be characterized by at least one of the following melt flow ratios (I₂₁/I₂) (i) to (iii): (i) a melt flow ratio (I₂₁/I₂) characterized by Equation (A): melt flow ratio (I₂₁/I₂) is greater than (−36.9*melt index (I₂))+68.0 (EQ. (A)), wherein * indicates multiplication, +Indicates addition, and the symbol for “greater than” is >; (ii) a melt flow ratio (121/12) characterized by Equation (B): melt flow ratio (I₂₁/I₂) is less than (−36.9*melt index (I₂))+80.0 (EQ. (B)), wherein * indicates multiplication, +indicates addition, and the symbol for “less than” is <; and (iii) a melt flow ratio (I₂₁/I₂) from 30 to 70. In some embodiments the C4-uLLDPE is characterized by any one of property combinations (iv) to (vii): (iv) melt flow ratio properties (i) and (ii); (v) melt flow ratio properties (i) and (iii); (vi) melt flow ratio properties (ii) and (iii); and (vii) each of melt flow ratio properties (i) to (iii). The high load melt index (I₂₁) is measured according to ASTM D1238-13, using conditions of 190° C./21.6 kg, and the melt index (I₂) is measured according to ASTM D1238-13, using conditions of 190° C./2.16 kg. In some embodiments the C4-uLLDPE has a melt flow ratio (I₂₁/I₂) from 35 to 64, alternatively from 35 to 40, alternatively from 50 to 62, alternatively from 51 to 55, alternatively from 57 to 63. To remove all doubt the “−36.9” is negative 36.9. The equations EQ. (A) and EQ. (B) seek to describe the C4-uLLDPE by delineating and further delineating, respectively, its melt rheology property space, which is believed to relate to the C4-uLLDPE's enhanced processability performance in processes of manufacturing films.

In some embodiments the unimodal linear low-density ethylene/1-butene copolymer has a short chain branching distribution that differs from short chain branching distribution of a reference unimodal linear low-density ethylene/1-hexene copolymer (Reference EH Copolymer, as defined herein), wherein the difference is called Delta (SCBD) and Delta (SCBD) is greater than 3%. The difference is expressed as a percentage and the EH Reference Copolymer meets the following requirements: (a) is synthesized with same catalyst and cocatalyst and same process and process conditions as used to synthesize the C4-uLLDPE Copolymer; (b) has a molecular weight distribution wherein at least one molecular weight moment M_{w}, Mₙ, or M_{z} is within plus-or-minus (±) 8% of the same at least one molecular weight moment M_{w}, Mₙ, or M_{z}, respectively, of the C4-uLLDPE Copolymer, both as measured by the GPC Test Method described herein in a same run queue; and (c) has a density that is within ±0.001 g/cm³ of the density of the C4-uLLDPE Copolymer, both as measured by ASTM D792-13. This percentage difference in SCBD values between the C4-uLLDPE and the Reference EH Copolymer is called “Delta (SCBD)” or “ASCBD” and is measured by comonomer content distribution analysis (iCCD) according to the Delta (SCBD) Test Method described later. In some embodiments the Delta (SCBD) is 5% or greater, alternatively from 5% to 40%, alternatively from 7% to 20%, alternatively from 8% to 18%, alternatively from 9.0% to 16.9%.

In some embodiments the C4-uLLDPE has a composition distribution breadth index (CDBI) greater than (“>”) 70%, alternatively >75%, alternatively >80%, alternatively >85%, alternatively >92%, alternatively >95%, alternatively >97%; and wherein the CDBI is less than or equal to 100%. The CDBI is defined as the weight percent of the polymer fractions having a co-monomer content within plus-or-minus (“±”) 50 percent (%) of the median co-monomer content (as reported in WO 93/03093). The CDBI is calculated by using short chain branching distribution measured by the iCCD method and with the comonomer composition correlation versus elution temperature as described later.

In some embodiments the C4-uLLDPE has a Mₙ from 20,000 to 30,000 grams per mole (g/mol), alternatively from 24,000 to 26,000 g/mol. The Mₙ is measured according to the High Temperature GPC Test Method described later.

In some embodiments the C4-uLLDPE has a M_{w} from 80,000 to 120,000 grams per mole (g/mol), alternatively from 88,000 to 112,000 g/mol. The M_{w} is measured according to the High Temperature GPC Test Method described later.

The inventive C4-uLLDPE may be made by copolymerizing ethylene and 1-butene using a bridged bis(tetrahydroindenyl) zirconocene catalyst under gas phase polymerization conditions, such as those described in the EXAMPLES later, to make the C4-uLLDPE. The bridged bis(tetrahydroindenyl) zirconocene catalyst is selected from the group consisting of: ethylene bis(4,5,6,7-tetrahydroindenyl) zirconium dichloride, ethylene bis(4,5,6,7-tetrahydroindenyl) zirconium dimethyl, dimethylsilyl bis(4,5,6,7-tetrahydroindenyl) zirconium dichloride, dimethylsilyl bis(4,5,6,7-tetrahydroindenyl) zirconium dimethyl, diphenylsilyl bis(4,5,6,7-tetrahydroindenyl) zirconium dichloride, diphenylsilyl bis(4,5,6,7-tetrahydroindenyl) zirconium dimethyl, diethylsilyl bis(4,5,6,7-tetrahydroindenyl) zirconium dichloride, and diethylsilyl bis(4,5,6,7-tetrahydroindenyl) zirconium dimethyl. The copolymerizing is carried out in a gas phase polymerization reactor and under gas phase polymerization conditions used in the UNIPOL™ PE Process. The UNIPOL™ PE Process has long been available from Univation Technologies, LLC, Houston, Texas, USA, and has been described in innumerable prior patents (“UNIVATION”). UNIVATION is a wholly-owned subsidiary of The Dow Chemical Company, Midland, Michigan, USA (“DOW”).

The bridged bis(tetrahydroindenyl) zirconocene catalyst used to make the C4-uLLDPE is made by contacting a bridged bis(tetrahydroindenyl) zirconium X₂ procatalyst with an activator (e.g., MAO), wherein X is halogen, alkyl, or benzyl; alternatively chloride or methyl; alternatively chloride. The bridged bis(tetrahydroindenyl) zirconium X₂ procatalyst may be selected from the group consisting of: ethylene bis(4,5,6,7-tetrahydroindenyl) zirconium dichloride, ethylene bis(4,5,6,7-tetrahydroindenyl) zirconium dimethyl, dimethylsilyl bis(4,5,6,7-tetrahydroindenyl) zirconium dichloride, dimethylsilyl bis(4,5,6,7-tetrahydroindenyl) zirconium dimethyl, diphenylsilyl bis(4,5,6,7-tetrahydroindenyl) zirconium dichloride, diphenylsilyl bis(4,5,6,7-tetrahydroindenyl) zirconium dimethyl, diethylsilyl bis(4,5,6,7-tetrahydroindenyl) zirconium dichloride, and diethylsilyl bis(4,5,6,7-tetrahydroindenyl) zirconium dimethyl. See U.S. patent number U.S. Pat. No. 8,957,159 B2. In some embodiments the bridged bis(tetrahydroindenyl) zirconocene catalyst is XCAT™ EZ-100 catalyst from UNIVATION. After copolymerizing is complete and prior to any post-reactor blending, post-reactor processing steps deactivate the catalyst such that the C4-uLLDPE is free of active catalyst and volatile organic compounds. The C4-uLLDPE may contain nonvolatile remnants of the bridged bis(tetrahydroindenyl) zirconocene catalyst, such as an inactive Zr salt.

The C4-uLLDPE may be formulated with one or more additives useful in polyethylene articles, such as but not limited to, films. In some embodiments the one or more additives comprise additives useful for films such as one or more antioxidants, one or more ultraviolet (UV) light stabilizers, one or more colorants, and/or one or more anti-microbial agents.

The C4-uLLDPE or formulation may be in the form of a melt at a temperature greater than 130° C. Alternatively the C4-uLLDPE or formulation may be in solid form of a powder, granules, or pellets.

The C4-uLLDPE or formulation thereof may be used without any other polyolefin polymer. For example, the C4-uLLDPE or formulation may be free of each of a low-density polyethylene, a reference linear low-density polyethylene that is different than the inventive C4-uLLDPE, a high-density polyethylene, a polypropylene, a halogenated polyolefin, a silicon-containing polyolefin, and a polyolefin terpolymer.

Another embodiment is a post-reactor blend comprising the unimodal linear low-density ethylene/1-butene copolymer and a different polyolefin polymer.

The post-reactor blend may be made by a method comprising: melting solids of the C4-uLLDPE to form a melt thereof; melting solids of the different polyolefin polymer to form a melt thereof; and mixing the melts together to form the post-reactor blend. The mixing step may be done before (e.g., as pellets), during (as pellets/partial melt), or after (as melts) the melting steps.

The C4-uLLDPE, formulation, or post-reactor blend has a balance of processability properties required for making a blown film and mechanical properties and abuse properties required for the blown film to be able to withstand forces and loads bulk packaging films suffer during shipping and storage. And yet the blown film comprising the C4-uLLDPE has increased directional tearability in the machine direction (MD), meaning a person is able to use their hands to manually tear open a film or package. This properties balance is achieved by combination of properties of the C4-uLLDPE described herein. This combination of properties is a result of making the C4-uLLDPE with bridged bis(tetrahydroindenyl) zirconocene catalyst under the gas phase polymerization conditions.

The C4-uLLDPE and post-reactor blend are useful for being manufactured into articles. The articles are not limited to films or articles made from or comprising films such as grocery bags and packaging wraps. Nevertheless the C4-uLLDPE is useful for making films and articles made from or comprising films such as grocery bags and packaging wraps.

Another embodiment is a film comprising the unimodal linear low-density ethylene/1-butene copolymer or the post-reactor blend.

In some embodiments the film is a monolayer film consisting of one layer and wherein the one layer comprises the unimodal linear low-density ethylene/1-butene copolymer or the post-reactor blend. In some embodiments if the film has a thickness of 0.0254 mm (1 mil) and is made under the film manufacturing conditions described in the EXAMPLES, the film is characterized by at least one of limitations (i) to (iii): (i) a stress at yield CD from 11.7 to 20.7 megapascals (MPa), (ii) a strain at break CD (elongation at break CD) from 630% to 690%, and/or (iii) a strain at break MD (elongation at break MD) from 510% to 530%. In some embodiments the directional tearability of the film is characterized by forming a monolayer embodiment of the film having a thickness of 0.0254 millimeter according the film forming procedure of any one of Inventive Examples 1 to 3 described later, measuring the Elmendorf Tear CD and Elmendorf Tear MD according to the Film Test Method for Elmendorf Tear Resistance described later, wherein the monolayer film has an Elmendorf Tear MD from 15 to 100 gram-force (gf), alternatively from 15 to 30 gf, alternatively from 21 to 99 gf; and, optionally an Elmendorf Tear Ratio CD/MD from 6.1 to 13, alternatively from 6.2 to 7.2, alternatively from 11.5 to 12.5.

In other embodiments the film is a multilayer film consisting of 3 to 12 layers wherein at least one of the 3 to 12 layers comprises the unimodal linear low-density ethylene/1-butene copolymer or the post-reactor blend.

The multilayer film may consist of 3 to 12 layers comprising 2 to 4 outer layers and 1 to 8 core layers; wherein at least one outer layer independently comprises from 10 to 100 wt %, alternatively from 70 to 100 wt % of the C4-uLLDPE and from 90 to 0 wt %, alternatively from 30 to 0 wt % of the other polyolefin polymer, all based on the total weight of the C4-uLLDPE+the other polyolefin polymer in the at least one outer layer, an wherein at least one core layer independently comprises from 80 to 100 wt % of the C4-uLLDPE and from 20 to 0 wt % of the other polyolefin polymer, all based on the total weight of the C4-uLLDPE+the other polyolefin polymer in the at least one core layer.

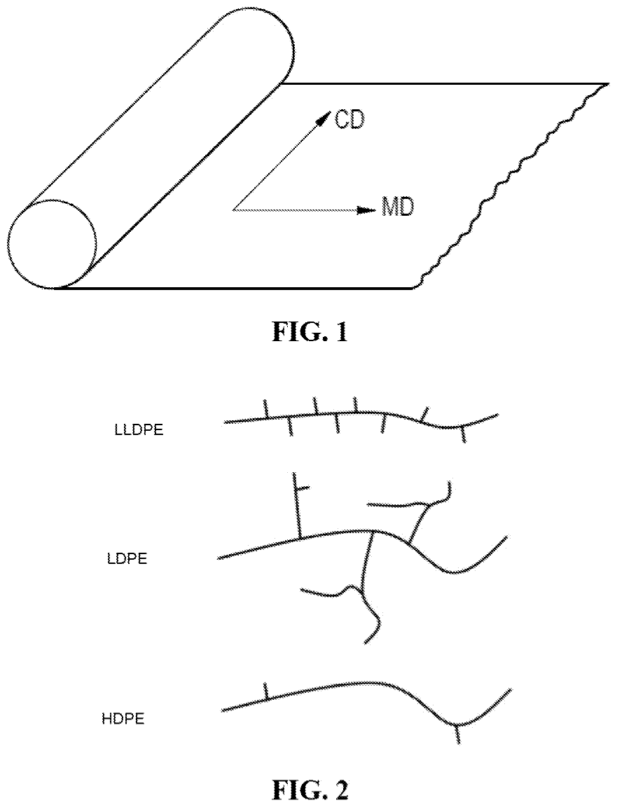

Another embodiment is a method of making a film comprising extruding at least one melt of the unimodal linear low-density ethylene/1-butene copolymer or the post-reactor blend as a film having at least one layer. In some embodiments the film is a monolayer film, the method comprising melt extruding through a single die hole a melt comprising the unimodal linear low-density ethylene/1-butene copolymer or the post-reactor blend, thereby making the monolayer film. An embodiment of the monolayer film, being mostly rolled up, is shown in FIG. 1.

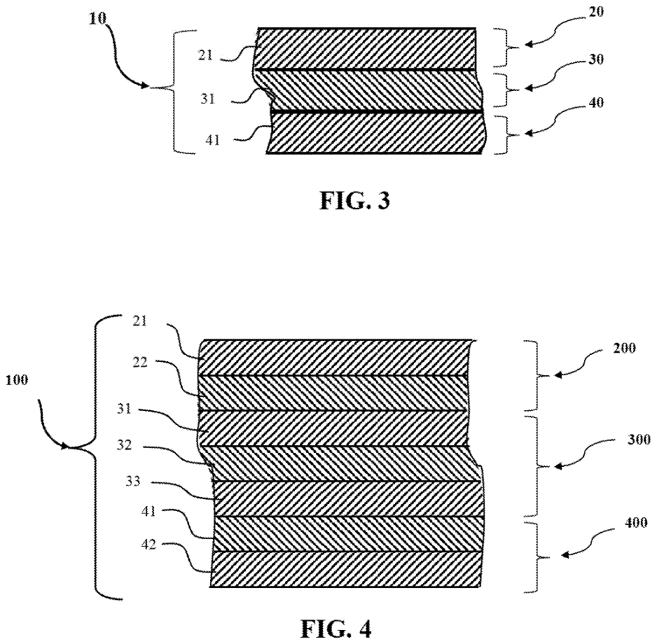

In other embodiments the film is a multilayer film, the method comprising melt extruding through different ones of from 3 to 12 die holes at least one melt comprising the unimodal linear low-density ethylene/1-butene copolymer or the post-reactor blend, and optionally through a different one of the die holes a melt comprising either the unimodal linear low-density ethylene/1-butene copolymer, a low-density polyethylene, a unimodal linear low-density ethylene/1-hextene copolymer, or a post-reactor blend thereof, thereby making the multilayer film consisting of 3 to 12 layers. Embodiments of the multilayer film is illustrated in FIGS. 3 and 4.

In a multilayer film laminate embodiment the method comprises melting one or more embodiments of the C4-uLLDPE, formulation, or post-reactor blend, and optionally a singleton C4-uLLDPE to give one or more melts thereof, and extruding the melts through separate extruders configured for forming a multilayer film laminate. An Alpine 7 film line may be used to do this wherein the multilayer film laminate consists of 3 layers as shown in FIG. 3 or 7 layers as shown in FIG. 4.

In a blown film embodiment, the method comprises melting the C4-uLLDPE or post-reactor blend to give a melt thereof, extruding the melt through a die configured for forming a bubble to make a bubble comprising the LLDPE copolymer, and blowing (inflating) the bubble with a film-blowing machine, thereby making the blown film. The C4-uLLDPE, formulation, or post-reactor blend has a balance of processability properties required for making a blown film and mechanical properties and abuse properties required for the blown film to be able to withstand forces and loads bulk packaging films suffer during shipping and storage.

Film making methods are well known. For example, see LyondellBasell, A Guide to Polyolefin Film Extrusion, Publication 6047/1004 (available at lyb.com) and Qenos Pty, Ltd., Film Extrusion and Conversion-Technical Guide (July 2015) (available at qenos.com).

A film comprising the above-described C4-uLLDPE, formulation, or post-reactor blend. The film is especially useful for packaging applications, such as food packaging made by standard film blowing methods and equipment.

Some embodiments of the film consist of a single layer (“monolayer film”), wherein the single layer is composed of the C4-uLLDPE, formulation, or post-reactor blend. FIG. 1 shows a roll of the monolayer film that has been partially unrolled (or incompletely rolled up) with perpendicular arrows to illustrate the machine direction (MD) and cross direction (CD). The inventive improvement in directional tear of the monolayer film means the monolayer film can be more easily torn in the machine direction (MD) or anti-machine direction (anti-MD), as the case may be, that in the cross direction (CD). Further, the MD and anti-MD tearability of the inventive monolayer film is increased relative to the MD and anti-MD tearability of a comparative monolayer film. The comparative monolayer film is one having the same thickness and prepared under the same film manufacturing conditions from a comparative linear low-density ethylene/1-hexene copolymer (“C6-uLLDPE”), made by copolymerizing ethylene and 1-hexene using the same bridged bis(tetrahydroindenyl) zirconocene catalyst, and wherein the comparative C6-uLLDPE has substantially the same density as the density of the inventive C4-uLLDPE, i.e., their densities are within +0.002 g/cm³, preferably +0.001 g/cm³ of each other; and wherein the comparative C6-uLLDPE has substantially the same melt flow ratio (I₂₁/I₂) as the melt flow ratio (I₂₁/I₂) of the inventive C4-uLLDPE, i.e., their I₂₁/I₂ values are within ±1.4, preferably ±1.1 of each other.

Other embodiments of the film consist of 2 or more layers (“multilayer film”), wherein at least one of the 2 or more layers is composed of the inventive C4-uLLDPE, formulation, or post-reactor blend and each of the other of the 2 or more layers independently is composed of a polyolefin composition selected from a polypropylene, a low-density polyethylene (LDPE), a single linear low-density polyethylene (LLDPE), a high-density polyethylene (HDPE), the inventive C4-uLLDPE, formulation, or post-reactor blend, or any combination of two or more such polyolefin compositions thereof. In some embodiments at least two of the 2 or more layers are independently composed of the inventive C4-uLLDPE, formulation, or post-reactor blend.

Some embodiments of the multilayer film may consist of 3 to 12 layers, alternatively 5 to 12 layers, alternatively 6 to 12 layers, alternatively 7 layers, wherein at least one of the aforementioned layers is composed of the C4-uLLDPE, formulation, or post-reactor blend. In some such embodiments the polyolefin composition of any two or more consecutive layers is different. In other embodiments the polyolefin composition of two or more consecutive layers is the same, and this is referred to herein as a “like layer grouping”.

In some embodiments the film consists of 3 or more layers wherein at least one of 3 or more the layers is a core layer (inner layer) that is composed of a low-density polyethylene (LDPE) and at least two of the 3 or more layers “sandwich” the core layer and are independently composed of the same or different C4-uLLDPE, formulation, or post-reactor blends.

An embodiment of the multilayer film comprising 3 layers is illustrated by 3-layer film 10 in FIG. 3. The 3-layer film 10 comprises a first outer layer (a skin layer or top layer) 20; a core layer (a middle layer) 30; and a second outer layer (a skin layer or bottom layer) 40. The core layer 30 is disposed in between the top layer 20 and the bottom layer 40, i.e., the two layers 20 and 40 sandwich the core layer 30. The top layer 20, the core layer 30, and the bottom layer 40 are contacted and bonded together to form the 3-layer film 10. The term “core layer” refers to any internal layer in a multilayer film; and the phrase “skin layer” refers to an outermost layer of a multilayer film.

Each of the layers 20, 30 and 40 of the multilayer film 10 in FIG. 3 is made as a distinct monolayer. Such a 3-layer film 10 in FIG. 3 is made by a film forming process combining 3 distinct layers in the following sequential arrangement: 20/30/40. All layers may be made simultaneously or sequentially or any combination thereof. Reference numerals 21, 32, and 41 are used in FIG. 3 simply to indicate the layers 20, 30, and 40 are made as distinct monolayers in the film forming process (whether simultaneously or sequentially). However, because the layers 20, 30, and 40 (21, 31, and 41) are made from melts of polyethylene compositions, these layers may undergo some interfacial mixing such that, in final form, a cross-section of the 3-layer film 10 may appear as having fewer than three total layers.

In other embodiments the 3-layer film 10 in FIG. 3 is a section of a larger multilayer film having from 4 to 12 total layers comprising 4 or more total layers. The layers 20, 30, and 40 may comprise any three consecutive layers of the multilayer film having 4 to 12 total layers. In some such embodiments layer 20 of 3-layer film 10 is an outer layer or top layer and layers 30 and 40 are core layers or inner layers of the multilayer film having from 4 to 12 total layers. In other embodiments each of layers 20, 30, and 40 are core layers or inner layers of the multilayer film having from 4 to 12 total layers.

In other embodiments the multilayer film has from 4 to 12 total layers An embodiment thereof is illustrated in 7-layer film 100 in FIG. 4.

In FIG. 4 like layer grouping 200 consists of like outer layers 21 and 22; like layer grouping 300 consists of like core layers 31, 32, and 33; and like layer grouping 400 consists of like outer layers 41 and 42. Layers 21 and 42 are outermost layers and layers 22 and 41 are outer layers immediately adjacent the outermost layers 21 and 42, respectively. Outer layer 22 is disposed between the outermost layer 21 and the core layer 31. Outer layer 41 is disposed between the outermost layer 42 and the core layer 33. Core layer 32 is disposed between core layers 31 and 33. In some embodiments the core layers 31, 32, and 33 are independently composed of LLDPE that is not part of the inventive C4-uLLDPE, formulation, or post-reactor blends and the layers outer 21, 22, 41, and 42 are independently composed of the same or different inventive C4-uLLDPE, formulation, or post-reactor blends.

The 7-layer film 100 in FIG. 4 is made by a film forming process combining 7 distinct layers in the following sequential arrangement: 21/22/31/32/33/41/42. This may be done by a 7-layer film line such as an Alpine 7-layer film extruder.

In some embodiments of the multilayer film (e.g., multilayer films 10 and 100 of FIGS. 2 and 3) at least one, alternatively each outer layer (e.g., layers 20 and 40 in the case of FIG. 3 or layers 21, 22, 41, and 42 in the case of FIG. 4), independently comprises from 10 to 100 wt % of the C4-uLLDPE and from 90 to 0 wt % of the C6-uLLDPE, alternatively from 10 to 60 wt % of the C4-uLLDPE and from 90 to 40 wt % of the C6-Ulldpe, alternatively from 20 to 50 wt % of the C4-uLLDPE and from 80 to 50 wt % of the C6-Ulldpe, alternatively 20-40 wt % of the C4-uLLDPE and 80-60 wt % of the C6-Ulldpe, all based on the total weight of the C4-uLLDPE+C6-uLLDPE in the outer layer. In some embodiments of the multilayer film (e.g., multilayer films 10 and 100 of FIGS. 2 and 3) at least one, alternatively each outer layer (e.g., layers 20 and 40 in the case of FIG. 3 or layers 21, 22, 41, and 42 in the case of FIG. 4), independently comprises from 70 to 98 wt % of the C4-uLLDPE and from 30 to 2 wt % of the C6-uLLDPE, alternatively from 80 to 97 wt % of the C4-uLLDPE and from 20 to 3 wt % of the C6-uLLDPE, alternatively from 86 to 94 wt % of the C4-uLLDPE and from 14 to 6 wt % of the C6-uLLDPE, alternatively 90 wt % of the C4-uLLDPE and 10 wt % of the C6-uLLDPE, all based on the total weight of the C4-uLLDPE+C6-uLLDPE in the outer layer.

In some embodiments of the multilayer film (e.g., the multilayer films 10 and 100 of FIGS. 2 and 3), at least one, alternatively each core layer (e.g., the middle layer 30 in the case of FIG. 3, or one or more of core layers 31, 32, and 33 in the case of FIG. 4), comprises from 80 to 100 wt % of the C4-uLLDPE and from 20 to 0 wt % of the C6-uLLDPE, alternatively from 85 to 100 wt % of the C4-uLLDPE and from 15 to 0 wt % of the C6-uLLDPE, alternatively from 95 to 100 wt % of the C4-uLLDPE and from 5 to 0 wt % of the C6-uLLDPE, alternatively 100 wt % of the C4-uLLDPE and 0 wt % of the C6-uLLDPE, all based on the total weight of the C4-uLLDPE+C6-uLLDPE in core layer.

In some embodiments of the multilayer film (e.g., the multilayer films 10 and 100 of FIGS. 2 and 3), at least one, alternatively each core layer (e.g., the middle layer 30 in the case of FIG. 3, or one or more of core layers 31, 32, and 33 in the case of FIG. 4), comprises from 20 to 100 wt % of the C4-uLLDPE and from 80 to 0 wt % of the C6-uLLDPE and/or HDPE, alternatively from 30 to 60 wt % of the C4-uLLDPE and from 70 to 40 wt % of the C6-uLLDPE and/or HDPE, alternatively from 30 to 50 wt % of the C4-uLLDPE and from 70 to 50 wt % of the C6-uLLDPE and/or HDPE, alternatively 40 wt % of the C4-uLLDPE and 60 wt % of the C6-uLLDPE and/or HDPE, all based on the total weight of the C4-uLLDPE+C6-uLLDPE and/or HDPE in core layer. The total wt % of C6-uLLDPE and/or HDPE may be from 100 to 0 wt % of C6-uLLDPE and 0 to 100% wt % of HDPE, based on the combined weight of C6-uLLDPE and HDPE. In some embodiments at least one layer of the film also contains a polyolefin composition that is not part of the inventive C4-uLLDPE, formulation, or post-reactor blend. Examples are the reference LLDPE, a low-density polyethylene (LDPE), or a high-density polyethylene (HDPE). In some embodiments the core layer 30 of the 3-layer film 10 in FIG. 3 or the core layers 31, 32, and 33 of the 7-layer film 100 in FIG. 4 is composed of a reference LLDPE that is not the C4-uLLDPE or the C6-uLLDPE and the layers 20 and 40 in FIG. 3 and the layers 21, 22, 41, and 42 in FIG. 4 are independently composed of the same or different inventive C4-uLLDPE, formulation, or post-reactor blends.

The method of making the film, the method comprising extruding through at least two different dies at least one melt of the C4-uLLDPE, formulation, or post-reactor blend, and optionally extruding a melt of the C4-uLLDPE through at least one different die, thereby making the multilayer film having 3 to 12 layers. The polyethylene film may be made using any film extrusion line configured for making a multilayer film or any blown-film-line machine configured for making polyethylene films.

The film extrusion line for making a multilayer film may be a film extrusion line configured for making a multilayer film having 3, 5, 7, 9, or up to 12 layers. An example of such a film extrusion line is an Alpine 7 film extruder configured for making a 7-layer multilayer film.

The blown film machine may be configured with a feed hopper in fluid communication with an extruder in heating communication with a heating device capable of heating a polyethylene in the extruder to a temperature of up to 500° C. (e.g., 430° C.), and wherein the extruder is in fluid communication with a die having an inner diameter of 20.3 centimeters (8 inches) and a fixed die gap (e.g., 1.778 millimeter gap (70 mils)), a blow up ratio of 2.5:1, and a Frost Line Height (FLH) of 76±10 centimeters (30±4 inches) from the die. Step (a) may be done in the feed hopper. Steps (b) and (c) may be done in the extruder and at a temperature of 400″ to 450° C. (e.g., 430° C.). Step (d) may be done in the die and after exiting the die. The machine may have capacity of a feed rate of (A) and (B), and production rate of film, from 50 to 200 kilograms (kg) per hour, e.g., 91 kg (201 pounds) per hour at 430° C.

The film is useful for making containers and wraps that have at least one enhanced optical property. Examples of such containers are bags such as ice bags and grocery bags. Examples of such wraps are stretch films, meat wraps, and food wraps.

The film description focuses on packaging applications, but the applications of the C4-uLLDPE, formulation, or post-reactor blend are not limited to packaging films or even films in general. Useful applications of the C4-uLLDPE, formulation, or post-reactor blend also include a variety of non-film articles such as car parts.

In some embodiments the film is a monolayer film comprising the C4-uLLDPE and free of any other polyolefin polymer and wherein the film is characterized by any one or more of the following properties: Elmendorf Tear in machine direction (“Elmendorf Tear MD”) and Elmendorf Tear in cross (transverse) direction (“Elmendorf Tear CD”), measured according to the Film Test Method for Elmendorf Tear Resistance described later; dart drop impact, measured according to the Film Test Method for Dart Drop Impact Resistance described later; gloss at 45°, measured according to the Film Test Method for Gloss described later; haze, measured according to the Film Test Method for Haze described later; secant modulus at 1% MD and secant modulus at 1% CD, measured according to the Film Test Method for 1% Secant Modulus described later; stress at yield CD and stress at yield MD, measured according to the Stress at Yield Test Method described later; strain at yield MD and strain at yield CD, measured according to the Strain at Yield Test Method described later; break stress MD and break stress CD, measured according to the Break Stress Test Method described later; and strain at break MD (also called elongation at break MD) and strain at break CD (also called elongation at break CD), measured according to the Stain at Break Test Method described later. Of particular interest for characterizing the directional tearability of the inventive film are the Elmendorf Tear MD and Elmendorf Tear CD/MD Ratio. Of particular interest for characterizing the overall toughness of the inventive film are the following properties: dart drop impact and the MD and CD properties of 1% secant modulus, stress at yield, strain at yield, break stress, and strain at break. Of particular interest for characterizing the optical properties of the inventive film are gloss at 45° and haze. For characterizing and comparing purposes any film thickness may be used to generate data for the foregoing film properties. In some embodiments the film thickness is 1 mil (0.025 millimeter (mm).

A manufactured article comprising an object and a film covering the object and having directional tearability and comprising the unimodal linear low-density ethylene/1-butene copolymer. The object may be anything in need of covering. Examples include foods (e.g., the manufactured article is a packaged food), boxes (e.g., the manufactured article is a wrapped grouping of boxes), and electronic items (e.g., the manufactured article is a wrapped electronic display or computer component). In some embodiments the directional tearability of the film is characterized by forming a monolayer embodiment of the film having a thickness of 0.0254 millimeter according the film forming procedure of any one of Inventive Examples 1 to 3 described later, measuring the Elmendorf Tear CD and Elmendorf Tear MD according to the Film Test Method for Elmendorf Tear Resistance described later, wherein the monolayer film has an Elmendorf Tear MD from 15 to 100 gram-force (gf), alternatively from 15 to 30 gf, alternatively from 21 to 99 gf; and, optionally an Elmendorf Tear Ratio CD/MD from 6.1 to 13, alternatively from 6.2 to 7.2, alternatively from 11.5 to 12.5.

Preparation Method: prepare test specimens, test plaques, or test sheets according to ASTM D4703-10, Standard Practice for Compression Molding Thermoplastic Materials into Test Specimens, Plaques, or Sheets.

Density Test Method: measure according to ASTM D792-13, Standard Test Methods for Density and Specific Gravity (Relative Density) of Plastics by Displacement, Method B (for testing solid plastics in liquids other than water, e.g., in liquid 2-propanol). Report results in units of grams per cubic centimeter (g/cm³).

Melt Index (“I₂”) Test Method: for ethylene-based (co) polymer is measured according to ASTM D1238-13, using conditions of 190° C./2.16 kg, formerly known as “Condition E”.

Molecular weights Mw (weight-average), Mn (number-average), and Mz (z-average) are measured according to the High Temperature Gel Permeation Chromatography (GPC) Test Method described below.

High Temperature Gel Permeation Chromatography (GPC) Test Method: was performed on the specimens to determine the Molecular Weight Distributions (MWD) of the samples and the samples' corresponding moments (Mn, Mw and Mz). The chromatographic system used to measure GPC included a Polymer Char GPC-IR high temperature GPC chromatograph (available from Polymer Char, Valencia, Spain) equipped with a 4-capillary differential viscometer detector and a IR5 multi-fixed wavelength infrared detector (available from Polymer Char). A Precision Detectors 2-angle laser light scattering detector Model 2040 (available from Precision Detectors, currently Agilent Technologies) was added to the chromatographic system. The 15-degree angle of the light scattering detector was used for calculation purposes. Data collection and data processing were performed using GPC One software (available from Polymer Char). The system was equipped with an on-line solvent degas device (available from Agilent Technologies).

Both the detector compartments and the column compartment of the chromatograph were operated at 150° C. The columns used were 4 PLgel Mixed A 7.5 mm×300 mm, 20-micron columns (Agilent Technology). The chromatographic solvent used was distilled 1,2,4 trichlorobenzene (TCB) which contained 200 ppm of butylated hydroxytoluene (BHT). The solvent source was nitrogen sparged. The injection volume used for each of the samples was 200 UL and the flow rate was 1.0 mL/min. Otherwise stated, samples were prepared in a semi-automatic manner with the PolymerChar “Instrument Control” Software, wherein the samples were weight-targeted at 2 mg/mL, and the solvent (contained 200 ppm BHT) was added to a pre nitrogen-sparged septa-capped vial, via the PolymerChar high temperature autosampler. The samples were dissolved for 2 hr at 160° C. under “low speed” shaking.

For conventional molecular weight measurements, the GPC column set was calibrated with 21 narrow molecular weight distribution polystyrene standards (available from Polymer Laboratories, now Varian) with molecular weights ranging from 580 to 8,400,000 and were arranged in 6 “cocktail” mixtures. The polystyrene standards were prepared at 0.025 g in 50 mL of solvent for molecular weights ≥1,000,000; and 0.05 g in 50 mL of solvent for molecular weights <1,000,000. The polystyrene standards were dissolved at 80° C. with gentle agitation for 30 min. The narrow standards mixtures were run first and in decreasing order from the highest molecular weight component to minimize degradation of the standards. The peak molecular weights of the polystyrene standards were converted to polyethylene molecular weights using the following Equation (I): M_{polyethylene}=A*(M_{polystyrene})\hat{ }B Equation (I), where in Equation (I), “M” is molecular weight of polystyrene or polyethylene; value “A” is 0.417; and value “B” is equal to 1.000. A third order polynomial was used to fit the respective polystyrene calibration points.

iCCD Test Method: “iCCD”, is an improved method for comonomer content distribution (CCD) analysis; and is based on the method described in WO2017040127A1. The test method was performed with crystallization elution fractionation (CEF) instrumentation (available from Polymer Char) equipped with an IR-5 detector and a two-angle precision detector light scattering detector Model 2040 (available from Agilent Technology). Ortho-dichlorobenzene (ODCB, 99% anhydrous grade or technical grade) was used as solvent. Silica gel 40 (with a particle size of 0.2 mm to ~0.5 mm; available from EMD Chemicals) can be used to dry the ODCB solvent. Dried silica was packed into three emptied HT-GPC columns (with dimensions of 300 mm×7.5 mm (ID)) to further purify the ODCB solvent as eluent. The CEF instrument is equipped with an autosampler with nitrogen (N₂) purging capability. ODCB was sparged with dried N₂ for 1 hr before use.

A sample was prepared using the autosampler at 4 mg/ml (unless otherwise specified) under shaking at 160° C. for 1 hour. The injection volume of the sample was 300 microliters (μL). The temperature profile of iCCD was as follows: crystallization at 3° C./minute from 105° C. to 30° C.; thermal equilibrium at 30° C. for 2 minutes (including Soluble Fraction Elution Time being set as 2 minutes); elution at 3° C./minute from 30° C. to 140° C. The flow rate of the sample during crystallization is 0.0 mL/minute. The flow rate of the sample during elution is 0.50 mL/minute. The data was collected at one data point/second.

The iCCD column used was a 15 cm (length)×¼ in internal diameter (ID) stainless tubing packed with gold coated nickel particles (Bright 7GNM8-NIS; available from Nippon Chemical Industrial Co.). The column packing and conditioning was carried out using a slurry method according to the method described in WO2017040127A1. The final pressure with trichlorobenzene (TCB) slurry packing was 150 bar (10 MPa).

The column temperature calibration was performed by using a mixture of: (i) 1.0 mg/ml of a unimodal linear homopolymer polyethylene (a polyethylene having a zero comonomer content, a melt index (I₂) of 1.0 g/cm³, and a polydispersity (M_{w}/Mₙ) of approximately 2.6 as determined by the GPC test method described above) as a “reference material”; mixed with 0.5 mg/ml of Eicosane in ODCB (Cong et al., J. Chromatography A, 1662 (2022) 462724. The iCCD temperature calibration consisted of four steps: (1) calculating the delay volume defined as the temperature offset between the measured peak elution temperature of Eicosane minus 30.00° C.; (2) subtracting the temperature offset of the elution temperature from iCCD raw temperature data (it is noted that this temperature offset is a function of experimental conditions, such as elution temperature, elution flow rate, etc.); (3) creating a unimodal linear calibration line transforming the elution temperature across a range of 30.00° C. and 140.00° C. so that the unimodal linear homopolymer polyethylene reference material had a peak temperature at 101.0° C., and Eicosane had a peak temperature of 30.0° C.; (4) for the soluble fraction measured isothermally at 30° C., the elution temperature below 30.0° C. is extrapolated linearly by using the elution heating rate of 3° C./min according to the method described in U.S. Pat. No. 9,688,795. GPCOne software (available from PolymerChar) is used to generate SCBD distribution curve dWi/dT where Wᵢ is the mass at Tᵢ, where Tᵢ is the elution temperature after calibration.

The comonomer content versus elution temperature of iCCD was constructed by using 12 reference materials (ethylene homopolymer and ethylene-octene random copolymer made with single site metallocene catalyst, having ethylene equivalent weight average molecular weight ranging from 35,000 to 128,000) with solution process. All of these reference materials were analyzed the same way as specified previously at 4 mg/mL. The correlation between comonomer mol fraction versus elution temperature (T in Celsius) follows the following expression: In (1-comonomer mol fraction)=−208.328/(elution temperature+273.12)+0.55846.

The composition distribution breadth index (CDBI) is defined as the weight percent of the polymer molecules having a co-monomer content within +/−50 percent of the median total molar co-monomer content (as reported in WO 93/03093). The CDBI of polyolefins can be conveniently calculated from the SCBD data obtained from the techniques known in the art, such as, for example, temperature rising elution fractionation (“TREF”) as described, for example, by Wild, et al., Journal of Polymer Science, Poly. Phys. Ed., Vol. 20, 441 (1982); L. D. Cady, “The Role of Comonomer Type and Distribution in LLDPE Product Performance,” SPE Regional Technical Conference, Quaker Square Hilton, Akron, OH, 107-119 (Oct. 1-2, 1985); and in U.S. Pat. Nos. 4,798,081 and 5,008,204.

Herein, iCCD CDBI is calculated accordingly by using short chain branching distribution measured by the iCCD method and with the comonomer composition correlation versus elution temperature as described above.

Delta (SCBD) Test Method: is used herein to calculate the percentage difference between the short chain branching distribution of the inventive unimodal linear low density ethylene/1-butene copolymer (“C4-uLLDPE Copolymer”) and the short chain branching distribution (SCBD) of a reference unimodal linear low density ethylene/1-hexene copolymer (“EH Reference Copolymer”). For determining Delta (SCBD), the EH Reference Copolymer meets the following requirements: (a) is synthesized with same catalyst and cocatalyst and same process and process conditions as used to synthesize the C4-uLLDPE Copolymer; (b) has a molecular weight distribution wherein at least one molecular weight moment M_{w}, Mₙ, or M_{z} is within plus-or-minus (±) 8% of the same at least one molecular weight moment M_{w}, Mₙ, or M_{z}, respectively, of the C4-uLLDPE Copolymer, both as measured by the GPC Test Method described herein in a same run queue; and (c) has a density that is within ±0.001 g/cm³ of the density of the C4-uLLDPE Copolymer, both as measured by ASTM D792-13. The Delta (SCBD) Test Method is performed according to the following procedure: (1) analyze the EH Reference Copolymer and the C4-uLLDPE Copolymer sequentially in a same run queue of an iCCD analysis to generate iCCD data for both copolymers, according to the iCCD method described elsewhere herein; (2) process the iCCD data of the EH Reference Copolymer and the iCCD data of the C4-uLLDPE Copolymer as stated above; (3) generate a cumulative distribution with a fixed temperature step of 0.1° C. per datapoint for the entire range of iCCD integration using the following mathematical equation:

$${\sum }_{lower elution temperature}^{upper elution temperaure} \frac{dWi}{dTi} = 1005 ;$$

(4) plot cumulative distribution versus elution temperature for each of the EH Reference Copolymer and the C4-uLLDPE Copolymer; (5) find the elution temperature of EH Reference Copolymer that corresponds to the cumulative distribution at 15.0% (“T15”); (6) find the elution temperature of EH Reference Copolymer that corresponds to the cumulative distribution at 75.0% (“T75”); (7) from the cumulative distribution curve of C4-uLLDPE Copolymer, obtain the corresponding cumulative wt %, dW/dT (T15) and dW/dT (T75), at the elution temperature of T15 and T75, respectively; (8) calculate the Delta (SCBD) as the sum of the difference between the SCBD of the EH Reference Copolymer and the SCBD of the C4-uLLDPE Copolymer according to this mathematical equation:

$$Delta ( SCBD ) = \frac{dW}{dT ( T 15 )} - 15 \% + ( \frac{dW}{dT ( T 75 )} - 75 \% ) ,$$

wherein Delta (SCBD) is expressed as a percent difference.

Long Chain Branching (LCB) Value Test Method: the amount of the LCB occurring in the EB LLDPE resins can be measured using a combination of nuclear magnetic resonance (NMR) techniques described in Z. Zhou, S. Pesek, J. Klosin, M. Rosen, S. Mukhopadhyay, R. Cong, D. Baugh, B. Winniford, H. Brown, K. Xu, “Long chain branching detection and quantification in LDPE with special solvents, polarization transfer techniques, and inverse gated ¹³C NMR spectroscopy”, Macromolecules, 2018, 51, 8443; Z. Zhou, C. Anklin, R. Cong, X. Qiu, R. Kuemmerle, “Long-chain branch detection and quantification in ethylene-hexene LLDPE with ¹³C NMR”, Macromolecule, 2021, 54, 757; and Z. Zhou, C. Anklin, R. Kuemmerle, R. Cong, X. Qiu, J. DeCesare, M. Kapur, R. Patel, “Very sensitive ¹³C NMR method for the detection and quantification of long-chain branches in ethylene-hexene LLDPE”, Macromolecule, 2021, 54, 5985. The chemical shift range for LCB calculation is between 38.12 ppm to 38.22 ppm.

Film Test Method for Clarity: measure optical property clarity according to ASTM D1746-15, Standard Test Method for Transparency of Plastic Sheeting. Measure clarity using the BYK-Gardner Haze-Gard Plus. Express clarity as the percentage ratio of the intensity of light with specimen and without specimen in the path of light.

Film Test Method for Dart Drop Impact Resistance: measure according to ASTM D1709-16, Standard Test Methods for Impact Resistance of Plastic Film by the Free-Falling Dart Method.

Film Test Method for Elmendorf Tear Resistance: measure in Cross Direction (CD) and Machine Direction (MD) according to ASTM D1922-15 (2020), Standard Test Method for Propagation Tear Resistance of Plastic Film and Thin Sheeting by Pendulum Method.

Film Test Method for Puncture Resistance: measure according to ASTM D5748-95 (2012), Standard Test Method for Protrusion Puncture Resistance of Stretch Wrap Film. Determines the resistance to puncture of a film as resistance to penetration of the film by a probe impinging the film at a standard speed such as 250 millimeters per minute (mm/min.). The probe is coated with a polytetrafluoroethylene and has an outer diameter of 1.905 cm (0.75 inch). The film is clamped during the test. The probe eventually penetrates or breaks the clamped film. The peak force at break, i.e., the maximum force, energy (work) to break or penetrate the clamped film, and the distance that the probe has penetrated at break, are recorded using mechanical testing software. The probe imparts a biaxial stress to the clamped film that is representative of the type of stress encountered by films in many end-use applications. This resistance is a measure of the energy-absorbing ability of a film to resist puncture under these conditions.

Film Test Method for Gloss: measure optical gloss according to ASTM D2457-13, Standard Test Method for Specular Gloss of Plastic Films and Solid Plastics. Measure specular gloss using a glassometer at an incident angle of 45°. Specular gloss is unitless.

Film Test Method for Haze: measure optical haze according to ASTM D1003-13, Standard Test Method for Haze and Luminous Transmittance of Transparent Plastics. Measure haze using a hazemeter. Express haze as percentage of luminous transmission which in passing through the film deviates from an incident beam by forward scattering.

Film Test Method for Hot Tack: measured using an Enepay commercial testing machine according to ASTM F-1921 (Method B). Prior to testing the samples are conditioned for a minimum of 40 hours at 23° C. and 50% relative humidity (R.H.). The hot tack test simulates the filling of material into a pouch or bag before the seal has had a chance to cool completely. Sheets of dimensions 8.5″ by 14″ are cut from the film, with the longest dimension in the machine direction. Strips 1″ wide and 14″ long are cut from the film [samples need only be of sufficient length for clamping]. Tests are performed on these samples over a range of temperatures and the results reported as the maximum load as a function of temperature. Typical temperature steps are 10° C. with 6 replicates performed at each temperature. The typical parameters used in the test are as follows: Specimen Width: 25.4 millimeters (mm, 1.0 inch); Sealing Pressure: 0.275 Newton per square millimeter (N/mm²); Sealing Dwell Time: 1.0 second (sec); Peel speed: 200 millimeters per second (mm/sec); Seal depth=12.7 mm (0.5 inch). Report data as a hot tack curve where Average Hot Tack Force in Newtons (N) is plotted as a function of temperature.

Film Test Method for 1% Secant Modulus: measure in Cross Direction (CD) and Machine Direction (MD) according to ASTM D882-12, Standard Test Methods for Tensile Properties of Thin Plastic Sheeting. Used 1% secant modulus in cross direction (CD) or machine direction (MD). Report results in megapascals (MPa). 1,000.0 pounds per square inch (psi)=6.8948 MPa.

Film Test Method for Zebedee Clarity: measure optical Zebedee clarity according to ASTM D1746-15, Standard Test Method for Transparency of Plastic Sheeting. Measure clarity using a Zebedee CL-100 Meter. Express Zebedee clarity as the percentage ratio of the intensity of light with specimen and without specimen in the path of light.

Stress at Yield Test Method: measure in Cross Direction (CD) and Machine Direction (MD) according to ASTM D882-12, Standard Test Method for Tensile Properties of Thin Plastic Sheeting.

Strain at Yield Test Method: measure in Cross Direction (CD) and Machine Direction (MD) according to ASTM D882-12.

Break Stress Test Method: measure in Cross Direction (CD) and Machine Direction (MD) according to ASTM D882-12.

Stain at Break Test Method: measure in Cross Direction (CD) and Machine Direction (MD) according to ASTM D882-12.

### Examples

Gas Phase Polymerization Procedure: Copolymerized ethylene and a comonomer (Cₓ, either 1-butene (Cₓ=C₄) or 1-hexene (Cₓ=C₆)) using XCAT™ EZ-100, a commercial bridged bis(tetrahydroindenyl) zirconocene catalyst, in a fluidized bed-gas phase polymerization (FB-GPP) reactor having a distribution grid to make a unimodal linear low-density ethylene/1-butene copolymer or a unimodal linear low-density ethylene/1-hexene copolymer, respectively. The FB-GPP reactor had a 0.35 meter (m) internal diameter and 2.3 m bed height and a fluidized bed composed of polymer granules. Flowed fluidization gas through a recycle gas loop comprising sequentially a recycle gas compressor and a shell-and-tube heat exchanger having a water side and a gas side. The fluidization gas flows through the compressor, then the water side of the shell-and-tube heat exchanger, then into the FB-GPP reactor below the distribution grid. Fluidization gas velocity is listed in Table 1 later. The fluidization gas then exits the FB-GPP reactor through a nozzle in the top of the reactor, and is recirculated continuously through the recycle gas loop. Maintained a constant fluidized bed temperature listed in Table 1 later by continuously adjusting the temperature of the water on the shell side of the shell-and-tube heat exchanger, Introduced feed streams of ethylene, nitrogen, and hydrogen together with the comonomer into the recycle gas line. Operated the FB-GPP reactor at a total pressure shown later in Table 1, and vented reactor gases to a flare to control the total pressure. Adjusted individual flow rates of ethylene, nitrogen, hydrogen and the comonomer (Cₓ) to maintain their respective gas composition targets. Set ethylene partial pressure, the Cₓ/C₂ molar ratio, and the H₂/C₂ molar ratio to the values shown in Table 1 later. Maintained isopentane (iC₅) concentration at the value shown in Table 1 later. Isopentane served as an induced condensing agent (ICA). The average copolymer residence times are shown in Table 1 later. Measured concentrations of all gasses using an on-line gas chromatograph. Maintained the fluidized bed at constant height by withdrawing a portion of the bed at a rate equal to the rate of formation of particulate product unimodal LLDPE. Product was removed semi-continuously via a series of valves into a fixed volume chamber. A nitrogen purge removed a significant portion of entrained and dissolved hydrocarbons in the fixed volume chamber. After purging, the product was discharged from the fixed volume chamber into a fiber pack for collection. The product was further treated with a small stream of humidified nitrogen to deactivate any trace quantities of residual catalyst and cocatalyst. Set the catalyst feeds at rates sufficient to maintain a production rate of the values shown below in Table 1 for the unimodal LLDPE products.

TABLE 1
Polymerization Conditions for making inventive C4-uLLDPE of Inventive Examples
1 to 3 and comparative C6-uLLDPE of Comparative Examples A to C.

| Polymerization Conditions | CE A | CE B | CE C | IE1 | IE2 | IE3 |
|---|---|---|---|---|---|---|
| XCAT ™ EZ-100 Catalyst | Yes | Yes | Yes | Yes | Yes | Yes |
| Monomer used | ethylene | ethylene | ethylene | ethylene | ethylene | ethylene |
| Comonomer Used | Hexene | Hexene | Hexene | Butene | Butene | Butene |
| Run number and sample | Run 1-1 | Run 1-2 | Run 1-3 | Run 2-1 | Run 2-2 | Run 2-3 |
| sequence | | | | | | |
| Bed Weight [kg] | 79.6 | 78.5 | 76.0 | 88.9 | 80.7 | 76.0 |
| Bed Temperature [°C] | 85 | 89 | 91 | 85 | 89 | 91 |
| Residence Time [hours] | 3.0 | 2.8 | 2.8 | 3.0 | 3.0 | 2.9 |
| Superficial Gas Velocity | 0.58 | 0.58 | 0.58 | 0.55 | 0.55 | 0.55 |
| [m/s] | | | | | | |
| Total Reactor Pressure | 2390 | 2390 | 2390 | 2408 | 2410 | 2415 |
| [kPa] | | | | | | |
| C₂ partial pressure [psia] | 200 | 200 | 200 | 200 | 200 | 200 |
| H₂/C₂ molar ratio | 11.63 | 8.39 | 6.30 | 12.27 | 8.32 | 6.52 |
| [ppm/mol %] | | | | | | |
| Cₓ/C₂ molar ratio [mol/mol] | 0.0091 | 0.0067 | 0.0038 | 0.0332 | 0.0218 | 0.0112 |
| C₂ concentration [mol %] | 55.3 | 55.3 | 55.4 | 54.9 | 55.1 | 54.9 |
| Cₓ concentration [mol %] | 0.5 | 0.4 | 0.2 | 1.8 | 1.2 | 0.6 |
| H₂ concentration [ppm] | 644 | 464 | 349 | 674 | 458 | 358 |
| iC₅ concentration [mol %] | 2.6 | 2.3 | 2.3 | 0.9 | 0.8 | 0.8 |
| N₂ concentration [mol %] | 42 | 42 | 42 | 42 | 43 | 44 |
| Production Rate [kg/hr] | 26.5 | 28.0 | 27.1 | 29.6 | 26.9 | 26.2 |

In Table 1, XCAT™ EZ-100 is a commercial bridged bis(tetrahydroindenyl) zirconocene catalyst from Univation Technologies, LLC, a Houston, Texas-headquartered, wholly-owned subsidiary of The Dow Chemical Company; Hexene is 1-hexene; Butene is 1-butene; kg/hr is kilograms per hour; kg is kilogram; kPa is kilopascals; m/s is meter per second; psia is pounds per square inch gauge+1 atmosphere; C₂ is ethylene; H₂ is hydrogen; Cₓ is comonomer; iC₅ is isopentane; N₂ is nitrogen; mol is moles; ppm is weight parts per million; mol % is mole percent.

The gas phase polymerization conditions in Table 1 show that embodiments of the inventive C4-uLLDPE copolymer spanning the claimed resin property ranges can be made using gas phase polymerization conditions and reactors and bridged bis(tetrahydroindenyl) zirconocene catalyst.

The resin properties of the inventive C4-uLLDPE of Inventive Examples 1 to 3 and comparative C6-uLLDPE of Comparative Examples A to C made according to the gas phase polymerization conditions listed in Table 1 above are reported in Table 2 below.

TABLE 2
Properties of inventive C4-uLLDPE and comparative C6-uLLDPE:

| Features | CE A | IE1 | CE B | IE2 | CE C | IE3 |
|---|---|---|---|---|---|---|
| LLDPE Monomer | ethylene | ethylene | ethylene | ethylene | ethylene | ethylene |
| LLDPE Comonomer | Hexene | Butene | Hexene | Butene | Hexene | Butene |
| LLDPE Modality | Uni- | Uni- | Uni- | Uni- | Uni- | Uni- |
| Density [g/cm³] | 0.921 | 0.922 | 0.928 | 0.928 | 0.936 | 0.937 |
| Melt index I₂ [g/10 min.] | 1.0 | 1.0 | 0.5 | 0.5 | 0.5 | 0.4 |
| (190 °C, 2.16 kg) | | | | | | |
| HLMI I₂₁ [g/10 min.] | 36.3 | 36.3 | 26.3 | 24.2 | 28.0 | 24.4 |
| (190 °C, 21.6 kg) | | | | | | |
| I₂₁/I₂ [unitless] | 36.1 | 37.0 | 51.5 | 52.6 | 59.6 | 59.6 |
| −36.0*I₂ + 68.0= | 31.1 | 31.1 | 49.5 | 49.5 | 49.5 | 53.2 |
| I₂₁/I₂ > −36.9*I₂ + 68.0 | Yes | Yes | Yes | Yes | Yes | Yes |
| [Yes/No] | | | | | | |
| −36.0*I₂ + 80.0= | 43.0 | 43.0 | 61.5 | 61.5 | 61.5 | 65.1 |
| I₂₁/I₂ < −36.9*I₂ + 80.0 | Yes | Yes | Yes | Yes | Yes | Yes |
| [Yes/No] | | | | | | |
| GPC Mw [g/mol] | 89,600 | 89,885 | 103,417 | 102,896 | 108,100 | 110,134 |
| GPC Mn [g/mol] | 23,720 | 24,292 | 24,238 | 25,898 | 23,427 | 25,448 |
| GPC Mw/Mn [unitless] | 3.8 | 3.7 | 4.3 | 4.0 | 4.6 | 4.3 |
| GPC Mz [g/mol] | 196,456 | 193,930 | 255,055 | 242,114 | 292,098 | 297,703 |
| Delta(SCBD) [%] | 0 | 16.4 | 0 | 15.2 | 0 | 9.1 |
| iCCD CDBI [%] | 85.1 | 83.0 | 82.5 | 80.8 | 80.2 | 76.2 |
| LCB Content 0.006 to | N/m | Yes [0.022] | N/m | N/m | N/m | Yes [0.028] |
| 0.050 LCB/1000 C | | | | | | |
| Yes/No [value] | | | | | | |

In Table 2, Hexene means 1-hexene; Butene means 1-butene; Uni-means unimodal; g/10 min. means grams per 10 minutes; GPC Mw and GPC Mn mean weight-average and number-average, respectively, molecular weight measured by the High Temperature Gel Permeation Chromatography Test Method described earlier; g/mol means grams per mole; Temp. means temperature; % means percent; wt % means weight percent; SCBI means short chain breadth index; and N/m means not measured.

The data in Table 2 show that the inventive C4-uLLDPE have basic resin properties suitable for melt processability, which is further evidenced by the data in Table 3 below.

TABLE 3
Film Extruder Line Parameters for making monolayer (1-Layer) Films 1 to 6:

| Film Making Conditions | CE A | | IE1 | | CE B | | IE2 | | CE C | | IE3 | |
|---|---|---|---|---|---|---|---|---|---|---|---|---|
| Die Size [in. (cm)] | 8 | (20.3) | 8 | (20.3) | 8 | (20.3) | 8 | (20.3) | 8 | (20.3) | 8 | (20.3) |
| Die Gap [mils (mm)] | 40 | (1.0) | 40 | (1.0) | 40 | (1.0) | 40 | (1.0) | 40 | (1.0) | 40 | (1.0) |
| Head Pressure [psi | 3689 | (25.43) | 3805 | (26.23) | 4119 | (28.40) | 4559 | (31.43) | 4096 | (28.24) | 4235 | (29.20) |
| (MPa)] | | | | | | | | | | | | |
| Frost Line Height [in. | 34 | (86) | 34 | (86) | 34 | (86) | 34 | (86) | 34 | (86) | 34 | (86) |
| (cm)] | | | | | | | | | | | | |
| Melt Temp. [°C] | 218 | | 220 | | 224 | | 225 | | 226 | | 226 | |
| Blow Up Ratio (BUR) | 2.5 | | 2.5 | | 2.5 | | 2.5 | | 2.5 | | 2.5 | |
| Actual Output Rate | 201 | (91.2) | 201 | (91.2) | 199 | (90.3) | 198 | (89.8) | 199 | (90.3) | 200 | (90.7) |
| [lbs/hr (kg/hr)] | | | | | | | | | | | | |
| Film Thickness [mil | 1 | (0.025) | 1 | (0.025) | 1 | (0.025) | 1 | (0.025) | 1 | (0.025) | 1 | (0.025) |

| | | | | | | |
|---|---|---|---|---|---|---|
| (mm)] | | | | | | |
| Film Defects? (Y/N) | No | No | No | No | No | No |

The film manufacturing conditions in Table 3 show that the inventive C4-uLLDPE resins have good melt processability, as indicated by a head pressure of less than 5,000 psi (less than 34.5 MPa), which enables the resins to be melt processed into very thin (0.025 mm thick) monolayer films without defects, i.e., without bubble instability, thickness variations, wrinkles, lines, rough surfaces due to melt fracture, holes, or tears. Therefore, the inventive C4-uLLDPE can be used for making monolayer and multilayer films.

TABLE 4
Properties of monolayer Films 1-6:

| Features | CE A | IE1 | CE B | IE2 | CE C | IE3 |
|---|---|---|---|---|---|---|
| LLDPE Monomer | ethylene | ethylene | ethylene | ethylene | ethylene | ethylene |
| LLDPE Comonomer | Hexene | Butene | Hexene | Butene | Hexene | Butene |
| LLDPE Modality | Uni- | Uni- | Uni- | Uni- | Uni- | Uni- |
| Film Thickness [mil | 1 | 1 | 1 | 1 | 1 | 1 |
| (mm)] | (0.025) | (0.025) | (0.025) | (0.025) | (0.025) | (0.025) |
| Dart Drop Impact [g] | 347 | 92 | 167 | 72 | 82 | 58 |
| Elmendorf Tear MD [gf] | 205 | 46 | 94 | 24 | 32 | 18 |
| Elmendorf Tear CD [gf] | 475 | 306 | 534 | 286 | 483 | 220 |
| Elmendorf Tear Ratio | 2.3 | 6.7 | 5.7 | 12 | 15 | 12 |
| CD/MD [unitless] | | | | | | |
| 1% Secant Modulus at | 37,454 | 37,003 | 55,232 | 53,788 | 77,850 | 82,342 |
| MD [psi (MPa)] | (258) | (255) | (381) | (371) | (537) | (568) |
| 1% Secant Modulus at | 41,571 | 40,801 | 63,545 | 62,449 | 95,726 | 98,390 |
| CD [psi (MPa)] | (287) | (281) | (438) | (431) | (660) | (678) |
| Stress at Yield MD | 1,594 | 1,554 | 2,081 | 2,125 | 2,581 | 2,741 |
| [psi (MPa)] | (11.0) | (10.7) | (14.3) | (14.6) | (17.8) | (18.9) |
| Stress at Yield CD | 1,626 | 1,731 | 2,233 | 2,249 | 2,836 | 2,947 |
| [psi (MPa)] | (11.2) | (11.9) | (15.4) | (15.5) | (19.5) | (20.3) |
| Strain at Yield MD [%] | 15 | 15 | 15 | 12 | 11 | 12 |
| Strain at Yield CD [%] | 15 | 15 | 12 | 11 | 10 | 10 |
| Break Stress MD | 5,111 | 4,251 | 5,435 | 5,216 | 5,281 | 5,453 |
| [psi (MPa)] | (35.2) | (29.3) | (37.5) | (36.0) | (36.4) | (37.6) |
| Break Stress CD | 4,792 | 3,956 | 5,526 | 4,214 | 4,590 | 4,165 |
| [psi (MPa)] | (33.0) | (27.3) | (38.1) | (29.0) | (31.6) | (28.7) |
| Strain at Break MD [%] | 468 | 528 | 447 | 514 | 467 | 525 |
| Strain at Break CD [%] | 572 | 675 | 596 | 632 | 629 | 683 |
| Gloss at 45° [unitless] | 50 | 50 | 46 | 42 | 32 | 32 |
| Haze [%] | 12 | 12 | 14 | 15 | 21 | 20 |

In Table 4, g is grams; gf is gram-force; psi is pound-force per square inch; MPa is megapascals.

The data in Table 4 show the improved (increased) directional tearability of the inventive films. This is illustrated by comparing the Elmendorf Tear MD values to the Elmendorf Tear CD values. The Elmendorf Tear MD property is a force measurement that is useful for characterizing directional tearability, which is the ability of the film to be torn in the machine direction. The lower the Elmendorf Tear MD value, beneficially the greater the directional tearability of the film. For example, comparing the film of CE A to the film of IE1, the Elmendorf Tear Ratio CD/MD is increased from 2.3 to 6.7 and comparing CE B to IE 2 the Elmendorf Tear Ratio CD/MD is increased from 5.7 to 12. The Elmendorf Tear Ratio CD/MD of 15 for CE C is already high and starting from CE C the Elmendorf Tear Ratio CD/MD for IE 3 decreased 20% to a still desirable 12. The absolute value of Elmendorf Tear MD for IE3 was improved (decreased) relative to that for CE C. An embodiment of the inventive monolayer film having a thickness of 0.0254 millimeter (mm; 1 mil) and made under the film manufacturing conditions described in the EXAMPLES may be characterized as having an Elmendorf Tear MD from 15 to 100 gram-force (gf), alternatively from 15 to 30 gf, alternatively from 21 to 99 gf. In some embodiments the improvement (increase) in directional tearability of the inventive film is characterized by any one of the foregoing Elmendorf Tear MD values in combination with an Elmendorf Tear Ratio CD/MD from 6.1 to 13, alternatively from 6.2 to 7.2, alternatively from 11.5 to 12.5. Thus, the inventive C4-uLLDPE resin can be used to manufacture blown LLDPE films that have improved (increased) directional tearability. The inventive films are easy to tear, i.e., less resistant to tearing, in the machine direction (MD) or anti-machine direction (opposite to MD), but difficult to tear in the cross direction (CD, also called transverse direction (TD)) or anti-cross direction.

The data in Table 4 also show that the inventive C4-uLLDPE resins and films have overall toughness properties suitable for withstanding abuse in shipping and handling of articles made therefrom. This is illustrated by the dart drop impact data and the MD and CD data for 1% secant modulus, stress at yield, strain at yield, break stress, and strain at break. For example, the stress at yield CD is a pressure measurement that is useful for characterizing the ability of the film to be hand-stretched and wrapped around an object, such as a pallet of stacked boxes, without breaking. The higher the pressure tolerated for stretching/wrapping, beneficially the greater the stretch/wrapability of the film without breaking. The embodiment of the inventive monolayer film having a thickness of 0.0254 mm (1 mil) and made under the film manufacturing conditions described in the EXAMPLES may be characterized as having a stress at yield CD from 11.7 to 20.7 megapascals (MPa; from 1,700 to 3,000 psi), alternatively from 15.1 to 20.7 MPa (from 2,200 to 3,000 psi), alternatively from to 11.7 to 15.9 MPa (from 1,700 to 2,300 psi). The strain at break MD and strain at break CD are percentage change measurements that are useful for characterizing the ability of the film to be stretched to longer lengths without breaking. These properties are prized by customers of stretch films as a way of comparing different stretch film products. The higher the percent stretch reached at break, beneficially the greater the stretchability of the film without breaking. The embodiment of the inventive monolayer film having a thickness of 0.0254 mm (1 mil) and made under the film manufacturing conditions described later in the EXAMPLES may be characterized as having a strain at break CD (elongation at break CD) from 630% to 690%, alternatively from 670 to 690%, alternatively from 630% to 674%. The embodiment of the inventive monolayer film having a thickness of 0.0254 (1 mil) and made under the film manufacturing conditions described in the EXAMPLES may be characterized as having a strain at break MD (elongation at break MD) from 510% to 530%, alternatively from 520 to 530%, alternatively from 510% to 526%.

Thus, the inventive C4-uLLDPE resins can be manufactured, have good toughness, good melt processability, and make films that achieve the technical solution described earlier. The inventive C4-uLLDPE resins have an overall toughness that enables them to hold up under the normal abuses of end use operations (e.g., a packaging operation such as wrapping a pallet of boxes with the film) and shipping and handling of the end use product (e.g., shipping and handling the wrapped pallet of goods). The inventive films also have good optical clarity and haze. The inventive films will allow end users, such as consumers, to tear open by hand a grocery bag, wrapped package, or container liner such as box or drum liner without the aid of a cutting blade and without unwanted tearing in the perpendicular direction, which could cause lead to containment of the materials held inside.

1. A unimodal linear low-density ethylene/1-butene copolymer that Is made by copolymerizing ethylene and 1-butene using a bridged bis(tetrahydroindenyl) zirconocene catalyst selected from the group consisting of: ethylene bis(4,5,6,7-tetrahydroindenyl) zirconium dichloride, ethylene bis(4,5,6,7-tetrahydroindenyl) zirconium dimethyl, dimethylsilyl bis(4,5,6,7-tetrahydroindenyl) zirconium dichloride, dimethylsilyl bis(4,5,6,7-tetrahydroindenyl) zirconium dimethyl, diphenylsilyl bis(4,5,6,7-tetrahydroindenyl) zirconium dichloride, diphenylsilyl bis(4,5,6,7-tetrahydroindenyl) zirconium dimethyl, diethylsilyl bis(4,5,6,7-tetrahydroindenyl) zirconium dichloride, and diethylsilyl bis(4,5,6,7-tetrahydroindenyl) zirconium dimethyl; wherein the unimodal linear low-density ethylene/1-butene copolymer is characterized be each of the following properties: a density from 0.915 to 0.939 gram per cubic centimeter (g/cm³) measured according to ASTM D792-13, Method B; a melt index (I₂) from 0.1 to 4.0 grams per 10 minutes (g/10 min.) measured according to ASTM D1238-13, using conditions of 190° C./2.16 kg; and a polydispersity index M_{w}/Mₙ from 3.0 to 5.0 measured according to the High Temperature Gel Permeation Chromatography (GPC) Test Method in the description.

2. The unimodal linear low-density ethylene/1-butene copolymer as claimed in claim 1 that has at least one of properties (i) to (iv): (i) a density from 0.921 to 0.939 g/cm³; (ii) a melt index (I₂) from 0.2 to 1.4 g/10 min.; (iii) a polydispersity index M_{w}/Mₙ from 3.5 to 4.5; and (iv) a long chain branching (LCB) content 0.005 to 0.050 per 1000 carbon atoms (content/1000C), measured by carbon-13 nuclear magnetic resonance (¹³C-NMR) spectroscopy according to the LCB Value Test Method in the description.

3. The unimodal linear low-density ethylene/1-butene copolymer as claimed in claim 1 characterized by at least one of the following melt flow ratios (I₂₁/I₂) (i) to (iii): (i) a melt flow ratio (I₂₁/I₂) characterized by Equation (A): melt flow ratio (I₂₁/I₂) is greater than (−36.9*melt index (I₂))+68.0 (EQ. (A)), wherein * indicates multiplication, +indicates addition, and the symbol for “greater than” is >; (ii) a melt flow ratio (I₂₁/I₂) characterized by Equation (B): melt flow ratio (I₂₁/I₂) is less than (−36.9*melt index (I₂))+80.0 (EQ. (B)), wherein * indicates multiplication, +indicates addition, and the symbol for “less than” is <; and (iii) a melt flow ratio (I₂₁/I₂) from 30 to 70; wherein the high load melt index (I₂₁) is measured according to ASTM D1238-13, using conditions of 190° C./21.6 kg, and the melt index (I₂) is measured according to ASTM D1238-13, using conditions of 190° C./2.16 kg.

4. The unimodal linear low-density ethylene/1-butene copolymer as claimed in claim 1 wherein the unimodal linear low-density ethylene/1-butene copolymer has a short chain branching distribution that differs from short chain branching distribution of a reference unimodal linear low-density ethylene/1-hexene copolymer (Reference EH Copolymer, as defined herein), wherein the difference is called Delta (SCBD) and Delta (SCBD) is greater than 3%.

5. A post-reactor blend comprising the unimodal linear low-density ethylene/1-butene copolymer as claimed in claim 1 and a different polyolefin polymer.

6. A film comprising the unimodal linear low-density ethylene/1-butene copolymer as claimed in claim 1.

7. The film as claimed in claim 6 wherein the film is a monolayer film consisting of one layer and wherein the one layer comprises the unimodal linear low-density ethylene/1-butene copolymer or the post-reactor blend.

8. The film as claimed in claim 7 wherein the film is a multilayer film consisting of 3 to 12 layers wherein at least one of the 3 to 12 layers comprises the unimodal linear low-density ethylene/1-butene copolymer or the post-reactor blend.

9. The film as claimed in claim 6, wherein if the film has a thickness of 0.0254 mm (1 mil) and is made under the film manufacturing conditions described in the EXAMPLES, the film is characterized by at least one of limitations (i) to (iii):
(i) a stress at yield CD from 11.7 to 20.7 megapascals (MPa),
(ii) a strain at break CD (elongation at break CD) from 630% to 690%, and/or
(iii) a strain at break MD (elongation at break MD) from 510% to 530%.

10. A method of making a film comprising extruding at least one melt of the unimodal linear low-density ethylene/1-butene copolymer of claim 1.

11. The method of making a film as claimed in claim 10 wherein the film is a monolayer film, the method comprising extruding through a single die hole a melt comprising the unimodal linear low-density ethylene/1-butene copolymer or the post-reactor blend, thereby making the monolayer film.

12. A method of making a film as claimed in claim 10 wherein the film is a multilayer film, the method comprising extruding through different ones of from 3 to 12 die holes at least one melt comprising the unimodal linear low-density ethylene/1-butene copolymer or the post-reactor blend, and optionally through a different one of the die holes a melt comprising either the unimodal linear low-density ethylene/1-butene copolymer, a low-density polyethylene, a unimodal linear low-density ethylene/1-hextene copolymer, or a post-reactor blend thereof, thereby making the multilayer film consisting of 3 to 12 layers.

13. A manufactured article comprising an object and a film covering the object and having directional tearability and comprising the unimodal linear low-density ethylene/1-butene copolymer as claimed in claim 1.
